(19) United States
(12) Patent Application Publication
(10) Pub. No.: US 2013/0149563 A1
(43) Pub. Date: Jun. 13, 2013

(54) BATTERY PACK

(71) Applicants: Seong-Joon Lee, Yongin-si (KR); Ki-Sik Pak, Yongin-si (KR)

(72) Inventors: Seong-Joon Lee, Yongin-si (KR); Ki-Sik Pak, Yongin-si (KR)

(73) Assignee: Samsung SDI Co.,Ltd., Yongin-si (KR)

(21) Appl. No.: 13/615,178

(22) Filed: Sep. 13, 2012

(30) Foreign Application Priority Data
Dec. 9, 2011 (KR) 10-2011-0132086

(51) Int. Cl. H01M 2/00

(52) U.S. Cl. 429/7

(57) ABSTRACT

A battery pack includes a bare cell, a protecting circuit module, a top case and an integrated insulator. The bare cell has a terrace part that is a sealing region positioned in an extraction direction of an electrode lead. The protecting circuit module is positioned at the terrace part and connected to the electrode lead. The top case surrounds the protecting circuit module. The integrated insulator covers at least the top case, and includes a first insulating member facing a top surface of the top case and having two first long sides opposite to each other and two first short sides opposite to each other, a second insulating member provided to extend from each of the first long sides and having a second long side and second short sides opposite to each other, and a third insulating member provided to extend from each of the second short sides.

### RELATED APPLICATIONS

This application claims priority to and the benefit of Korean Patent Application No. 10-2011-0132086, filed on Dec. 9, 2011, in the Korean Intellectual Property Office, the entire content of which is incorporated herein by reference.

### BACKGROUND

1. Field

An aspect of the present invention relates to a battery pack, and more particularly, to a battery pack capable of improving safety and reliability by preventing an external foreign matter from coming into the inside thereof.

2. Description of the Related Art

In general, secondary batteries refer to rechargeable batteries that, unlike primary batteries, cannot be recharged. The secondary batteries are widely used in electronic devices such as a cellular phone, a notebook computer and a camcorder.

Among various kinds of secondary batteries, a lithium secondary battery is widely used because of its high operating voltage and high energy density per unit weight. The lithium secondary battery is manufactured in several shapes: and cylinder-type, can-type and pouch-type secondary batteries are used as representative shapes of the lithium secondary batteries.

The pouch-type secondary battery is formed by inserting an electrode assembly into a pouch and sealing the pouch, and an electrode lead connected to an electrode tab of the electrode assembly is connected to a component such as a protecting circuit module (PCM) or positive temperature coefficient (PTC), thereby forming a core pack. A top case for surrounding the PCM is formed at an upper part of the core pack, and the core pack is built in a hard case or surrounded by a label for packing, thereby forming a battery pack.

### SUMMARY

Embodiments provide a battery pack in which the structure of an outer insulating tape opposite to a top case is changed, so that it is possible to prevent or inhibit damage of components mounted on a protecting circuit module and to prevent or inhibit an external foreign matter from coming into the inside thereof.

According to an aspect of the present invention, there is provided a battery pack including: a bare cell having a terrace part that is a sealing region positioned in an extraction direction of an electrode lead; a protecting circuit module positioned at the terrace part and connected to the electrode lead; a top case surrounding the protecting circuit module; and an integrated insulator covering at least the top case, the insulator including a first insulating member facing a top surface of the top case and having two first long sides opposite to each other and two first short sides opposite to each other, a second insulating member provided to extend from each of the first long sides and having a second long side and second short sides opposite to each other, and a third insulating member provided to extend from each of the second short sides.

The insulator may further include a fourth insulating member extended from each of the first short sides.

Bending lines may be formed at interfaces between the first to fourth insulating members, respectively.

The insulator may cover a partial region of the bare cell.

The battery pack may further include a flexible circuit board formed to be connected to the protecting circuit module.

The flexible circuit board may be formed to extend to at least one surface of the bare cell, and have a connector for external terminal connection on at least a partial region thereof.

The insulator may accommodate the flexible circuit board.

The top case may be formed in a shape.

The top case may surround a mounting surface of a component of the protecting circuit module, a connection surface between the protecting circuit module and the electrode lead and the other surface that is a surface opposite to one surface of the protecting circuit module, facing the terrace part.

The top case may have a groove formed in a region corresponding to the electrode lead.

The insulator may be an insulation tape.

An adhesive layer may be further formed between a top surface of the bare cell and the top case.

The battery pack may further include a pouch-type battery case accommodating the bare cell.

According to the present invention, the structure of an outer insulating tape opposite to a top case is changed, so that it is possible to prevent damage of components mounted on a protecting circuit module and to prevent an external foreign matter from coming into the inside thereof, thereby ensuring the safety and reliability of the battery pack.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a battery pack according to an embodiment of the present invention.

FIG. 2 is an exploded perspective view showing a state in which a top case is separated from the battery pack according to the embodiment of the present invention.

FIG. 3 is a development view of an insulator according to the embodiment of the present invention.

FIG. 4 is a development view of an insulator according to another embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. In the drawings, the thickness or size of layers are exaggerated for clarity and not necessarily drawn to scale.

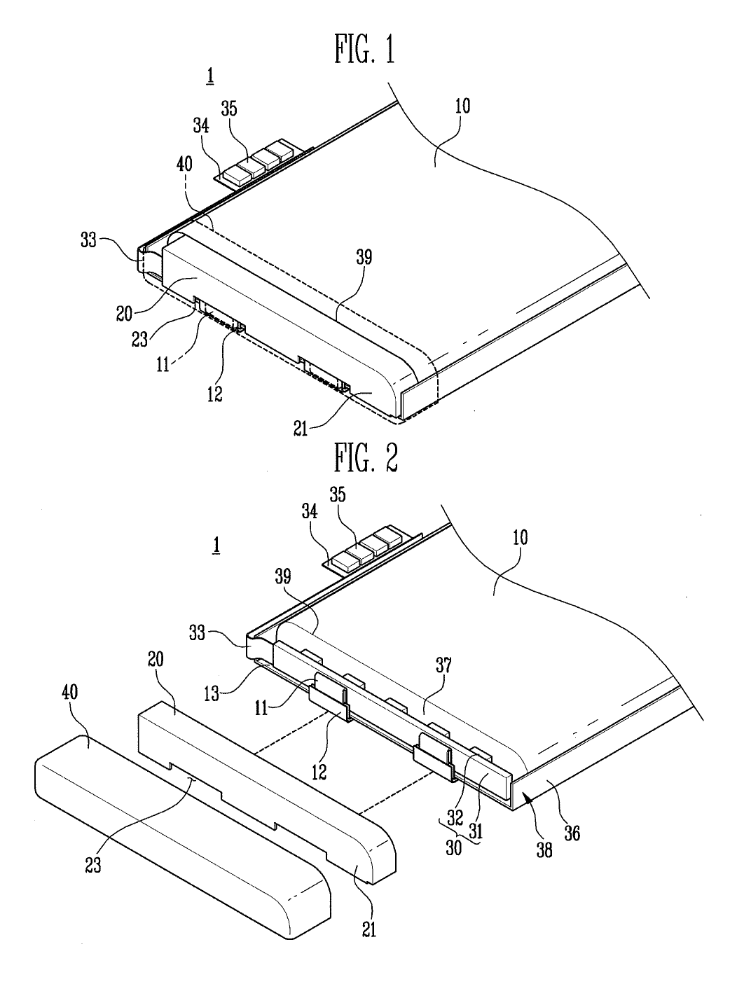

FIG. 1 is a perspective view of a battery pack according to an embodiment of the present invention. FIG. 2 is an exploded perspective view showing a state in which a top case is separated from the battery pack according to the embodiment of the present invention. FIG. 3 is a development view of an insulator according to the embodiment of the present invention.

Referring to FIGS. 1 to 3, the battery pack 1 according to this embodiment includes a pouch-type bare cell 10, a protecting circuit module 30, a top case 20 for surrounding the protecting circuit module 30, and an integrated insulator 40 having first to third insulating members or regions 41, 42 and 43 to cover the top case 20.

The pouch-type bare cell 10 accommodates an electrode assembly (not shown) in the inside thereof, and has a terrace part 13 that is a sealing region positioned in the extraction direction of an electrode lead 11 connected to an electrode tab of the electrode assembly. The protecting circuit module 30 connected to the electrode lead 11 is positioned at the terrace part 13. In this case, the top case 20 may be formed in a ‘⊂’ shape so as to surround the protecting circuit module 30.

That is, the top case 20 may surround a mounting surface of components 32 of the protecting circuit module 30, a connection surface between a protecting circuit board 31 and the electrode lead 11 and the other surface of the protecting circuit module 30, which is a surface opposite to one surface of the protecting circuit module 30 facing the terrace part 13.

The terrace portion 13 in one implementation is formed by a first surface 37 that can, in some implementations, be a sealing surface of the bare cell 10 that forms the sealing region of the bare cell 10 as well as a lip 38 that surrounds the first surface 37. In this implementation, the lip 38 is formed of a wrapper that surrounds three sides of the first surface 37.

Here, the first insulating member or region 41 of the insulator 40 has two first long sides 41a opposite to each other and two first short sides 41b opposite to each other. The second insulating member or region 42 is provided to extend from each of the first long sides 41a of the first insulating member 41, and has a second long side 42a opposite to the first long side 41a and a second short side 42b formed on an extension line with each of the first short sides 41b. The third insulating member or region 43 is provided to extend from each of the second short sides 42b, and has a third long side 43a formed on an extension line with each of the second long sides 42a and a third short side 43b formed in parallel with each of the first short sides 41b. A bending line is formed on each of the first long sides 41a and the second short sides 42b, respectively positioned at interfaces between the first to third insulating members or regions 41, 42 and 43, and the insulator 40 may be bent along the bending lines.

The insulator 40 is an insulation tape, and may cover the top case 20 while facing the top case 20. The insulator 40 may further extended to cover a partial region of the bare cell 10. The integrated insulator 40 configured as described above can cover the top case 20 and a partial region of the bare cell 10 without a gap between the insulator 40 and the top case 20. Thus, it is possible to prevent or at least inhibit the component 32 from being damaged by the inflow of an external foreign matter when an impact between the component 32 and the top case 20 occurs.

As is shown in FIG. 1, the insulating member or region 41 is positioned adjacent an upper surface 21 of the top case 20. The second insulating members or regions 42 are positioned proximate the first and second long sides 39 of the first surface 37 of the bare cell 10 and the third insulating members 43 are positioned adjacent the first and second short sides 36 of the first surface 37 of the bare cell 10.

Hereinafter, components of the battery pack according to the present invention will be described.

The electrode assembly is accommodated in the inside of a pouch of the pouch-type bare cell 10, and the pouch-type bare cell 10 has the terrace part 13 that is the sealing region positioned in the extraction direction of the electrode lead 11 connected to the electrode tab of the electrode assembly. Parts of the sealing region respectively positioned at both sides of the terrace part in the extraction direction of the electrode lead 11 are adhered closely to the pouch while being bent to sides of the pouch.

A metal thin plate such as an aluminum thin plate formed by performing an insulation process on the surface thereof is frequently used as the pouch. For example, in the pouch, casted polypropylene (CPP) that is polymer resin is coated as a thermal adhesive layer on an aluminum thin plate, and a resin material such as nylon or polyethylene terephthalate (PET) is formed on the outer surface of the thermal adhesive layer.

The electrode assembly accommodated in the inside of the pouch has a structure in which a positive electrode plate, a negative electrode plate and a separator interposed therebetween are sequentially stacked or wound. Electrode tabs attached to the positive and negative electrode plates of the electrode assembly are electrically connected to electrode leads 11 having different polarities, respectively. Parts of the electrode leads 11 are exposed to the terrace part 13 of the pouch so as to be electrically connected to the protecting circuit module 30 in a subsequent process.

In this case, an insulation tape 12 is further formed on an outer surface of each of the electrode leads 11 positioned at the terrace part 13. The insulation tape 12 may be formed so as to improve the sealing force between the electrode lead 11 and the pouch and to ensure electrical insulation of the electrode leads 11.

The protecting circuit module 30 is positioned at the terrace part 13 of the bare cell 10, and has positive and negative electrode terminals electrically connected to the respective electrode leads on one surface thereof. The other surface of the protecting circuit module 30 has a form in which various types of electronic components 32 are mounted on the protecting circuit board 31 having a protecting circuit part printed therein. A flexible circuit board 33 extended from the protecting circuit board 31 may be further provided to one end part of the protecting circuit board 31. The flexible circuit board 33 is formed to extend to at least one surface of the bare cell 10, and may have a connector 34 for external terminal connection on at least a partial region thereof. Connector components 35 may be mounted on the connector 34 so as to be connected to an external power source.

Here, the insulator 40 may accommodate and cover the flexible circuit board 33. The integrated insulator 40 according to this embodiment can cover the top case 20, the flexible circuit board 33 and the partial region of the bare cell 10. Thus, it is possible to prevent or at least inhibit the component 32 or the flexible circuit board 33 from being damaged by the inflow of the external foreign matter when the impact between the component 32 and the top case 20 occurs. The insulator 40 covers an upper part of the bare cell 10 so that the top case 20 can be easily fixed to the terrace part 13 of the bare cell 10.

The top case 20 surrounds the protecting circuit module 30 so as to protect the protecting circuit module 30, and is mounted on the top surface of the bare cell 10, i.e., the terrace part 13 of the bare cell 10. In the top case 20, a groove 23 is formed in a region corresponding to each of the electrode leads 11 so as to avoid interference between the top case 20 and the electrode leads 11. In this case, the insulation tape 12 is formed to extend up to an outer surface of the electrode lead 11 exposed through the groove 23 of the top case 20, so that it is possible to prevent or at least inhibit a short circuit between the top case 20 and the electrode lead 11. An adhesive layer (not shown) may be further provided between the top surface of the bare cell 10 and the top case 20 so as to more improve a bonding force between the bare cell 10 and the top case 20.

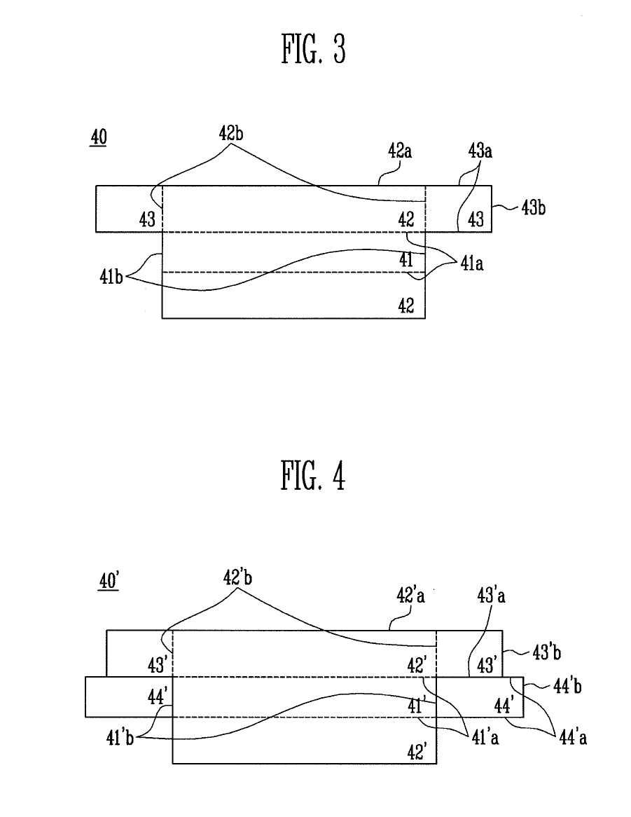

FIG. 4 is another view of an insulator according to another embodiment of the present invention.

Referring to FIG. 4, a first insulating member or region 41′ of the insulator 40′ has two first long sides 41′a opposite to each other and two first short sides 41′b opposite to each other. A second insulating member 42′ is provided to extend from each of the first long sides 41′a of the first insulating member or region 41′, and has a second long side 42′a opposite to the first long side 41′a and a second short side 42′b formed on an extension line with each of the first short sides 41′b. A third insulating member or region 43′ is provided to extend from each of the second short sides 42′b, and has a third long side 43′a formed on an extension line with each of the second long sides 42′a and a third short side 43′b formed in parallel with each of the first short sides 41′b. Unlike the embodiment shown in FIG. 3, the insulator 40′ according to this embodiment is provided with a fourth insulating member or region 44′ having a fourth long side 44′a provided to extend from the first short side 41′b and formed on an extension line with the first long side 41′a, and a fourth short side 44′b formed in parallel with the first short side 41′b. A bending line is formed on each of the first long sides 41′a, the second short sides 42′b and the first short sides 41′b, respectively positioned at interfaces between the first to fourth insulating members or regions 41′, 42′, 43′ and 44′, and the insulator 40′ may be bent along the bending lines. When the insulator 40′ is bent along the bending lines so at to cover the top case 20, the flexible circuit board 33 and the partial region of the bare cell 10, the second and third insulating members or regions 42′ and 43′ are separated from each other along the length of the third insulating member or region 43′ or partially overlapped with each other at a side of the top case 20 or the bare cell 10. Unlike the embodiment shown in FIG. 3, the insulator 40′ according to this embodiment has the fourth insulating member or region 44′, so that it is possible to more firmly fix the second and third insulating members or regions 42′ and 43′ separated from each other or partially overlapped with each other. Further, it is possible to prevent the component 32 or the flexible circuit board 33 from being damaged by the inflow of the external foreign matter.

The insulator 40′ is an insulation tape, and may cover the top case 20 while facing the top case 20. The insulator 40 may further extended to cover a partial region of the bare cell 10. The integrated insulator 40′ configured as described above can cover the top case 20 and a partial region of the bare cell 10 without a gap between the insulator 40′ and the top case 20. Thus, it is possible to prevent or at least inhibit the component 32 from being damaged by the inflow of an external foreign matter when an impact between the component 32 and the top case 20 occurs (See FIG. 2).

According to the present invention, the structure of an outer insulating tape opposite to a top case is changed, so that it is possible to prevent or at least inhibit damage of components mounted on a protecting circuit module and to prevent an external foreign matter from coming into the inside thereof, thereby ensuring the safety and reliability of the battery pack.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery pack comprising:
a bare cell having an electrode lead and a terrace part that is a sealing region positioned in an extraction direction of the electrode lead;
a protecting circuit module positioned at the terrace part and connected to the electrode lead;
a top case surrounding the protecting circuit module; and
an integrated insulator covering at least the top case, the insulator comprising a first insulating member facing a top surface of the top case and having two first long sides opposite to each other and two first short sides opposite to each other, a second insulating member provided to extend from each of the first long sides and having a second long side and second short sides opposite to each other, and a third insulating member provided to extend from each of the second short sides.

2. The battery pack according to claim 1, wherein the insulator further comprises a fourth insulating member extended from each of the first short sides.

3. The battery pack according to claim 2, wherein bending lines are formed at interfaces between the first to fourth insulating members, respectively.

4. The battery pack according to claim 1, wherein the insulator covers a partial region of the bare cell.

5. The battery pack according to claim 1, further comprising a flexible circuit board formed to be connected to the protecting circuit module.

6. The battery pack according to claim 5, wherein the flexible circuit board is formed to extend to at least one surface of the bare cell, and has a connector for external terminal connection on at least a partial region thereof.

7. The battery pack according to claim 5, wherein the insulator accommodates the flexible circuit board.

8. The battery pack according to claim 1, wherein the top case is formed in a ‘⊂’ shape.

9. The battery pack according to claim 8, wherein the top case surrounds a mounting surface of a component of the protecting circuit module, a connection surface between the protecting circuit module and the electrode lead and the other surface that is a surface opposite to one surface of the protecting circuit module, facing the terrace part.

10. The battery pack according to claim 1, wherein the top case has a groove formed in a region corresponding to the electrode lead.

11. The battery pack according to claim 1, wherein the insulator is an insulation tape.

12. The battery pack according to claim 1, wherein an adhesive layer is further formed between a top surface of the bare cell and the top case.

13. The battery pack according to claim 1, further comprising a pouch-type battery case accommodating the bare cell.

14. A battery pack comprising:
a bare cell having an electrode lead and a first surface, wherein the first surface defines a sealing region of the bare cell and has a first and a second long sides and a first and a second narrow sides wherein the bare cell further comprises a lip that extends about the first surface adjacent at least one of the first and second long sides and both of the first and second short narrow sides;
a protecting circuit module positioned adjacent the first surface that is connected to the first lead;
a top case having a top surface that is mounted adjacent the protection circuit module so as to at least partially cover the top case;
a flexible insulator that is positioned to at least partially cover the top case, wherein the flexible insulator includes a first insulating region that is positioned adjacent the top surface of the top case, a first and a second long side insulation regions that are positioned adjacent the first and second long sides of the first surface and a first and second narrow side insulation regions that are positioned adjacent the first and second narrow sides of the first surface.

15. The battery pack of claim 14, wherein the first surface of the sealing region and the lip define a terrace part.

16. The battery pack of claim 14, wherein the first and second narrow side regions are formed so as to be connected to the ends of the first long side insulation region of the flexible insulator.

17. The battery pack of claim 16, wherein the flexible insulator comprises an additional insulating region that extends from the first and second narrow insulation regions and is positioned proximate the first and second narrow side regions so as to overlap the first and second narrow side regions of the flexible insulator when the first and second narrow side regions are positioned adjacent the first and second narrow sides of the first surface.

18. The battery pack of claim 14, wherein bending lines are formed between the first insulation region and the first and second long side insulation regions.
